(19) United States
(12) Patent Application Publication
(10) Pub. No.: US 2007/0061551 A1
(43) Pub. Date: Mar. 15, 2007

(54) Computer Processor Architecture Comprising Operand Stack and Addressable Registers

(75) Inventor: Michael Andrew Fischer, San Antonio, TX (US)

Correspondence Address: DEMONT & BREYER, LLC, 100 COMMONS WAY, STE. 250, HOLMDEL, NJ, 07733, US

(73) Assignee: FREESCALE SEMICONDUCTOR, INC., Austin, TX (US)

(21) Appl. No.: 11/470,732

(22) Filed: Sep. 7, 2006

Related U.S. Application Data
(60) Provisional application No. 60/723,165, filed on Oct. 3, 2005.
(60) Provisional application No. 60/716,806, filed on Sep. 13, 2005.
(60) Provisional application No. 60/723,699, filed on Oct. 5, 2005.

(51) Int. Cl. G06F 9/30

(52) U.S. Cl. 712/202

(57) ABSTRACT

A computer processor architecture is disclosed that exhibits both the speed of register-oriented architectures in the prior art and the code efficiency of stack-oriented machines in the prior art. The illustrative embodiment accomplishes this by providing an operand stack and a stack-oriented instruction set but also a set of general registers and a set of instructions that enable the illustrative embodiment to substitute the general registers and literals for the stack in any operation. The result is a processor that can function as a traditional stack-oriented machine, a register-oriented machine, or a new hybrid stack-register machine on an instruction-by-instruction basis.

### REFERENCE TO RELATED APPLICATIONS

The following patent applications are incorporated by reference:

i. U.S. Patent Application 60/716,806, entitled “Multi-Threaded Processor Architecture,” filed 13 Sep. 2005, Attorney Docket 163-001us;

ii. U.S. Patent Application 60/723,699, entitled “Computer Processor Capable of Responding with Comparable Efficiency to Both Software-State-Independent and State-Dependent Events,” filed 5 Oct. 2006, Attorney Docket 163-002us; and

iii. U.S. Patent Application 60/723,165, entitled “Computer Processor Architecture Comprising Operand Stack and Addressable Registers,” filed 3 Oct. 2006, Attorney Docket 163-003us.

### FIELD OF THE INVENTION

The present invention relates to computer engineering in general, and, more particularly, to the design of a computer processor.

### BACKGROUND OF THE INVENTION

There are a variety of computer architectures in the prior art, and two of them are: (1) zero-address or “stack-oriented” architectures and (2) operand-addressed or “general-register” oriented architectures. Each of these classes has its advantages and it's disadvantages. The salient characteristics of the stack-oriented architecture are described below and with respect to FIGS. 1 through 3, and the salient characteristics of the general-register architecture are described below and with respect to FIGS. 4 through 6.

FIG. 1 depicts a block diagram of the salient components of the central data path of a stack-oriented processor in the prior art. A stack-oriented processor uses a last-in, first-out data structure called a “stack” for its scratchpad memory. The first-in, last-out nature of the stack means that the location of the operands and the resultant of the results of operations are implicit. This eliminates most of the need for arithmetic instructions to be accompanied by bits that specify the addresses of the operands and the resultant of the result. In turn, this is advantageous in processors where the program memory's bandwidth is a constraint on the processor's performance because it means that programs can be usually encoded in fewer bits than programs for a processor with a general-register orientation. This saving of bits is also advantageous in systems where the size, cost, and power consumption of program memory needs to be reduced.

The central data path of processor 100 comprises: stack register file 101, top-of-stack register 102, arithmetic logic unit 103, and multiplexor 104, interconnected as shown.

Stack register file 101 and top-of-stack register comprise operand storage for processor 100. The top of the stack is stored in top-of-stack register 102 and the lower portion of the stack is stored in stack registers S0 through S15 in stack register file 101 (as depicted in FIG. 2). The registers in the lower portion of the stack are “addressed” via the stack pointer, and, are not, therefore, a part of the programmer's model of processor 100.

Arithmetic logic unit 103 performs the logical and arithmetic operations on the operands that are presented to it by stack register file 101 and top-of-stack register 102. The output of arithmetic logic unit 103 can be written to main memory (which is not shown in the figures), stack register file 101, and top-of-stack register 102 via multiplexor 104.

Multiplexor 104 is a three-to-one multiplexor that selects one of:
i. a literal value that is given to it by the instruction decoder (which is not shown in the figures),
ii. the output of arithmetic logic unit 104, and
iii. a value from memory
   for storage in either stack register file 101 or top-of-stack register 102, under the control of the instruction decoder.

FIG. 3 depicts a program—using a typical instruction set for a stack-oriented machine like processor 100—for evaluating the expression:
X=(A+B)−(A+7*C) (Expression 1)
The program comprises 10 instructions, which occupies 22 bytes of code, and can execute in as few as 10 cycles (without requiring a superscalar data path).

At task 301, the LOAD A instruction copies the value of A from memory and pushes it onto the stack.

At task 302, the LOAD B instruction copies the value of B from memory and pushes it onto the stack.

At task 303, the ADD instruction pops A and B off of the stack, adds them, and pushes the sum back onto the stack.

At task 304, the LOAD A instruction copies the value of A from memory (again) and pushes it onto the stack.

At task 305, the LITERAL 7 instruction pushes the literal value of 7 onto the stack.

At task 306, the LOAD C instruction copies the value of C from memory and pushes it onto the stack.

At task 307, the MUL instruction pops 7 and C from the stack, multiplies them, and pushes the product back onto the stack.

At task 308, the ADD instruction pops A and the product of 7 and C off of the stack, adds them, and pushes the sum back onto the stack.

At task 309, the SUB instruction pops (A−(7*C)) and (A+B) off of the stack, subtracts them, and pushes the difference back onto the stack.

At task 310, the STORE X instruction pops the result X off of the stack and stores it into memory.

FIG. 4 depicts a block diagram of the salient components of the central data path of a register-oriented processor in the prior art. A register-oriented processor uses an array of addressable general-purpose registers for its scratchpad memory. Whenever the processor performs an arithmetic or logical operation, each operand can come from any of the registers and the result of any arithmetic operation can be written into any register. This generality means that the location of the operands and the resultant of the results of operations must be explicitly specified with each operation. This creates the need for arithmetic instructions to be accompanied by bits that specify the addresses of the operands and the resultant of the result.

Although a register-oriented architecture is advantageous because it can efficiently retain the values of frequently-referenced variables and sub-expressions, which eliminates the need for redundant memory accesses like those in tasks 301 and 304 above, the bits that specify the addresses of the operands and the resultant of the result consume memory and can—in processors where the program memory's bandwidth is a constraint on the processor's performance—slow the processor's performance. The extra bits are also disadvantageous in systems where the size, cost, and power consumption of program memory needs to be reduced.

The central data path of processor 400 comprises: register file 401, multiplexor 402, arithmetic logic unit 403, and multiplexor 404, interconnected as shown.

Register file 401 comprises the operand storage for processor 400 in the form of 16 general registers designated R0 through R15 (as depicted in FIG. 5). Register file 401 comprises two independent read ports and one write port, and each of general registers R0 through R15 is independently addressable and any operand can be read from any register and the result of any arithmetic operation can be written into any register.

Multiplexor 402 is a two-to-one multiplexor that selects one of:
i. a literal value that is given to it by the instruction decoder (which is not shown in the figures), or
ii. the output of one of general registers R0 through R15
   for delivery as one of the operands to arithmetic logic unit 403.

Arithmetic logic unit 403 performs the logical and arithmetic operations on the operands that are presented to it by multiplexor 402 and one of general registers R0 through R15. The output of arithmetic logic unit 403 can be written to main memory (which is not shown in the figures) or any of general registers R0 through R15 via multiplexor 404.

Multiplexor 404 is a two-to-one multiplexor that selects one of:

i. the output of arithmetic logic unit 404, and

ii. a value from memory

for storage in any of general registers R0 through R15, under the control of the instruction decoder.

FIG. 6 depicts a program—using a typical instruction set for a register-oriented machine like processor 400—for evaluating Expression 1. The program comprises 9 instructions, which occupy 36 bytes of code, and can execute in 9 cycles.

At task 601, the LOAD A, R1 instruction copies the value of A from memory and stores it in general register R1.

At task 602, the LOAD B, R2 instruction copies the value of B from memory and stores it in general register R2.

At task 603, the LDI #7, R3 instruction stores the value “7” in general register R3.

At task 604, the LOAD C, R4 instruction copies the value of B from memory and stores it in general register R4.

At task 605, the ADD R1, R2, R5 instruction adds A and B and stores the sum in general register R5.

At task 606, the MUL R3, R4, R3 instruction multiplies 7 times C and stores the product into general register R3, which overwrites the literal “7,” which was in general register R3.

At task 607, the ADD R1, R3, R3 instruction adds A to (7*C) and stores the sum in general register R3.

At task 608, the SUB R5, R3, R5 instruction subtracts (A−(7*C)) from (A+B) and stores the difference back into general register R5.

At task 609, the STORE R5, X instruction stores the contents of general register R5 into memory.

The need exists, therefore, for a computer processor architecture that avoids some of the costs and disadvantages associated with processor architectures in the prior art.

### SUMMARY OF THE INVENTION

The present invention enables a computer processor architecture that avoids some of the costs and disadvantages associated with processor architectures in the prior art. In particular, the illustrative embodiment exhibits both the speed of register-oriented architectures in the prior art and the code efficiency of stack-oriented machines in the prior art.

The illustrative embodiment accomplishes this by providing an operand stack and a stack-oriented instruction set but also a set of general registers and a set of instructions that enable the illustrative embodiment to substitute the general registers and literals for the stack in any operation. The result is a processor that can function as a traditional stack-oriented machine, a register-oriented machine, or a new hybrid stack-register machine on an instruction-by-instruction basis.

The illustrative embodiment comprises:

(a) a stack comprising a plurality of stack registers;

(b) a first general register;

(c) a second general register;

(d) a third general register;

(e) an instruction decoder for capable of decoding and orchestrating the performance of:

(i) a first instance of a zero-address dyadic instruction in which the first operand is read from said first general register, the second operand is read from said second general register, and the resultant is stored into said third general register; and

(ii) a second instance of said zero-address dyadic instruction in which the first operand is popped off of said stack, said second operand is popped off of said stack, and the resultant is pushed onto said stack.

### BRIEF DESCRIPTION OF THE DRAWINGS

FIG. 1 depicts a block diagram of the salient components of the central data path of a stack-oriented processor in the prior art.

FIG. 2 depicts a block diagram of the salient components of stack register file 101.

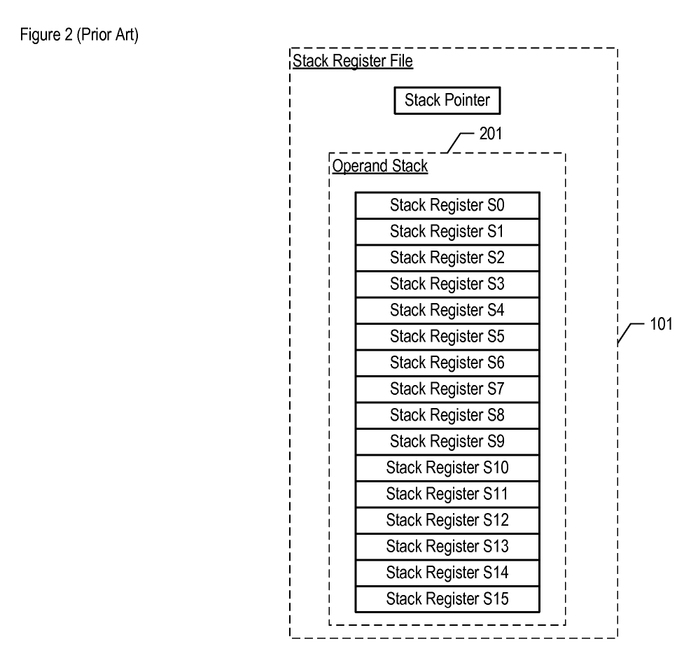

FIG. 3 depicts a program—using a typical instruction set for a stack-oriented machine like processor 100—for evaluating Expression 1.

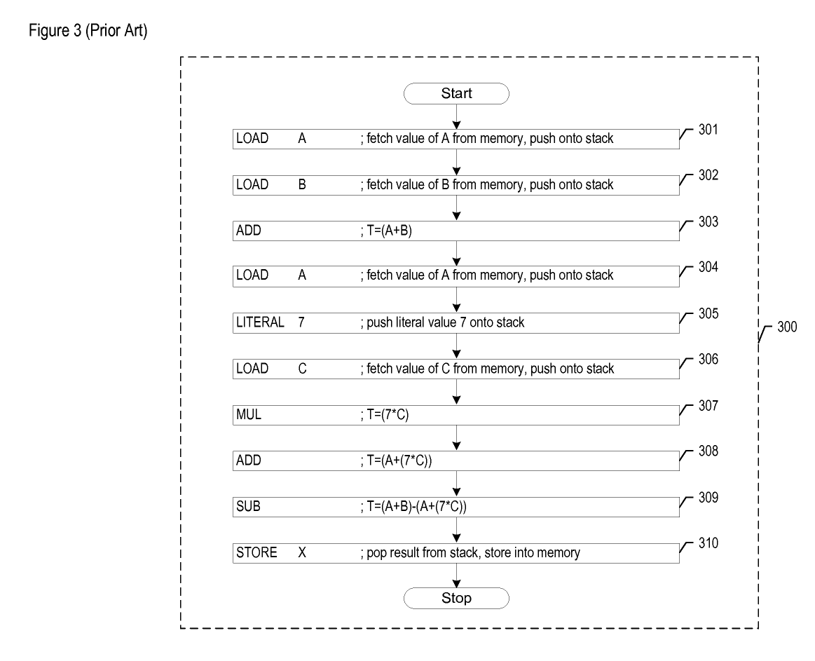

FIG. 4 depicts a block diagram of the salient components of the central data path of a register-oriented processor in the prior art.

FIG. 5 depicts a block diagram of the salient components of register file 401.

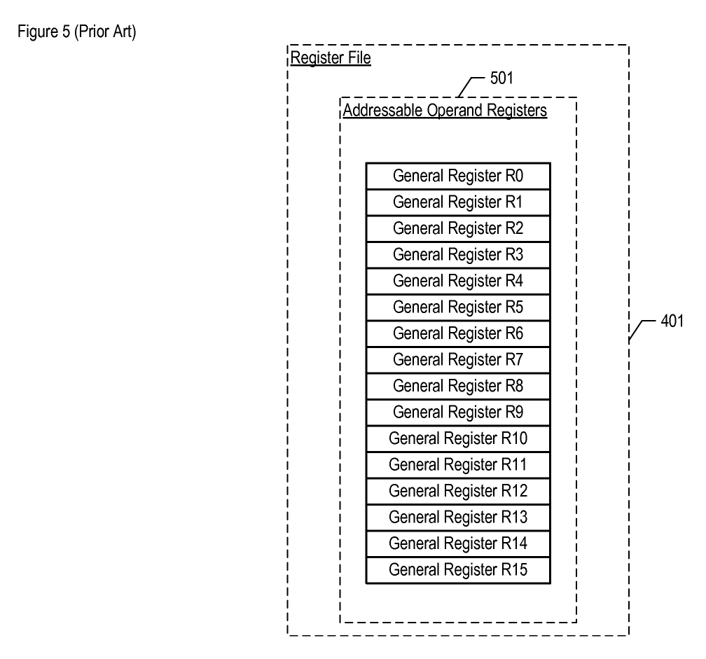

FIG. 6 depicts a program—using a typical instruction set for a register-oriented machine like processor 400—for evaluating Expression 1.

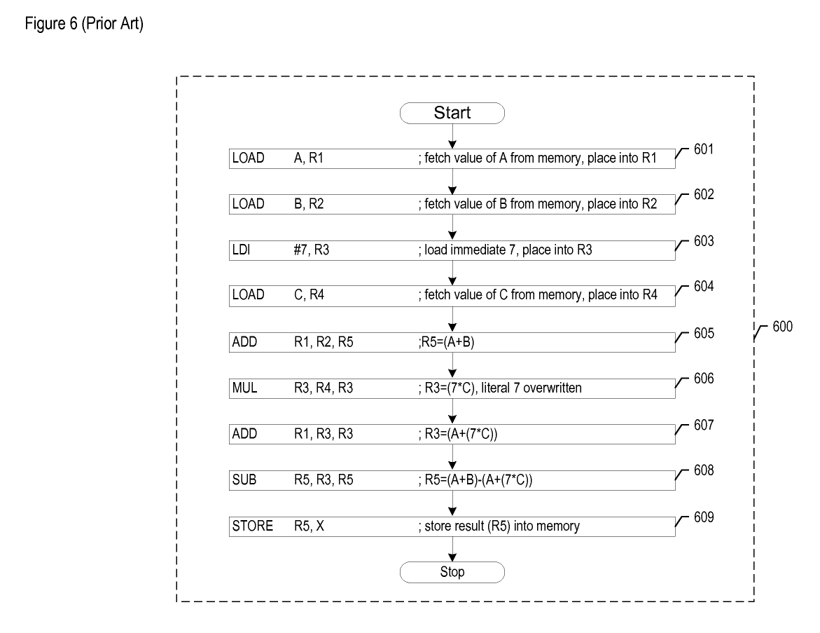

FIG. 7 depicts a block diagram of the salient components of the illustrative embodiment, which is the central data path of a processor.

FIG. 8 depicts a block diagram of the salient components of register file 701.

FIG. 9 depicts the instruction format of 15 instructions in accordance with the illustrative embodiment, which has a 32-bit data path and a programming model that comprises a stack and 16 general registers.

FIG. 10 depicts the instruction format of 7 operand specifier instructions in accordance with the illustrative embodiment.

FIG. 11 depicts a flowchart of the operation of the illustrative embodiment for evaluating Expression 1.

### DETAILED DESCRIPTION

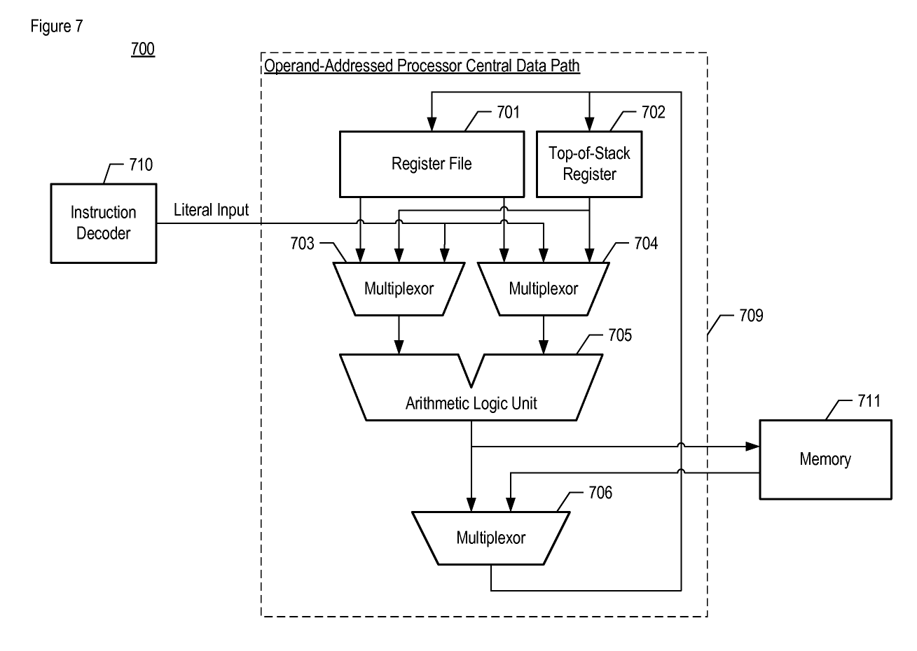

FIG. 7 depicts a block diagram of the salient components of the illustrative embodiment. Processor 700 comprises: central data path 709, instruction decoder 710, and memory 711, interconnected as shown, and central data path 709 comprises: register file 701, top-of-stack register 702, multiplexor 703, multiplexor 704, arithmetic logic unit 705, and multiplexor 706, interconnected as shown. The circuitry that instruction decoder 710 uses to control the other elements is not depicted, but will be clear to those skilled in the art after reading this disclosure.

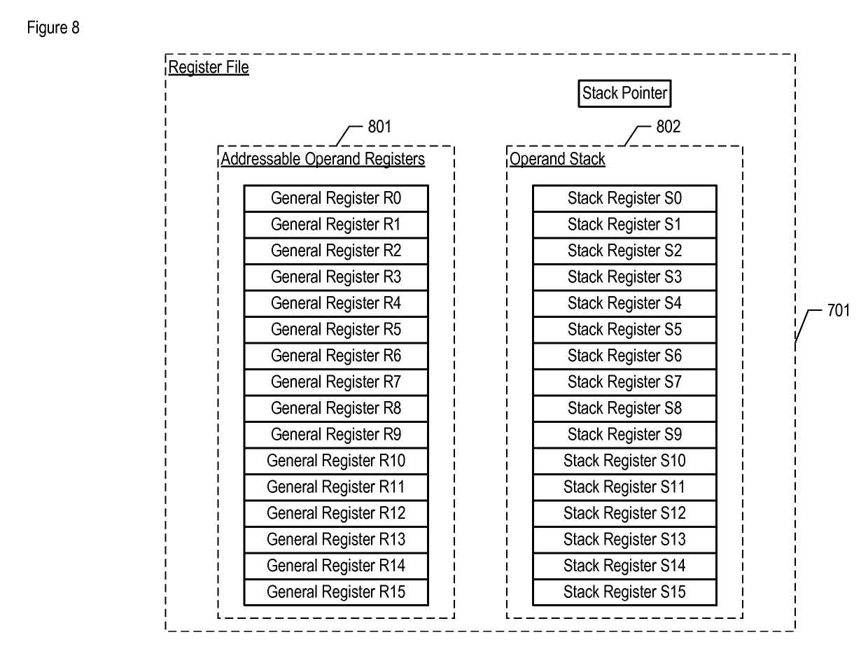

Register file 701 comprises a 32-word memory and a stack pointer. Register file 701 comprises one write port and two independent read ports and that is depicted in detail in FIG. 8. Sixteen of the registers—general registers R0 through R15—comprise addressable registers 801 and are directly addressable in the programmer's model of processor 700. The other sixteen registers—stack registers S0 through S15—compose the lower portion of an operand stack whose top is stored in top-of-stack register 702. The registers in the lower portion of the stack are indirectly “addressed” via the stack pointer, and, are not, therefore, directly addressable in the programmer's model of processor 700. It will be clear to those skilled in the art, after reading this disclosure, how to make and use alternative embodiments of the present invention that comprise any number of general registers and any number of stack registers. Furthermore, it will be clear to those skilled in the art, after reading this disclosure, how to make and use alternative embodiments of the present invention that comprise a plurality of registers wherein each of those registers can be dynamically designated as either stack registers or general registers.

Register file 701 comprises two independent read ports that enable it to:

(1) output to multiplexor 703 via the first read port:
i. the contents of any one of general registers R0 through R15; or
ii. the contents of the stack register pointed to by the stack pointer, which is designated herein as stack register “N”; and

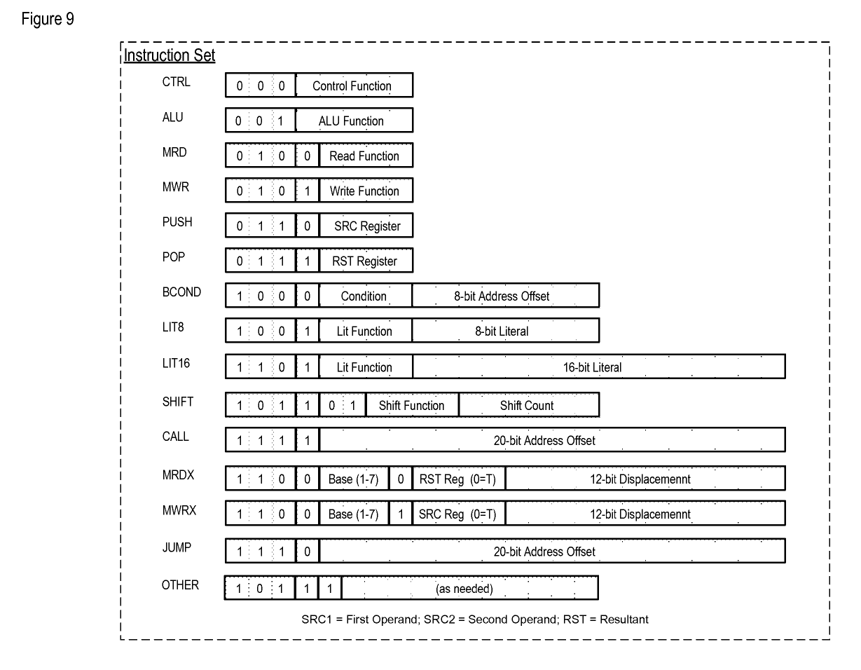

(2) simultaneously output to multiplexor 704 via the second read port:
i. the contents of any one of general registers R0 through R15; or
ii. the contents of stack register N.
   This characteristic of register file 701, and the inclusion of multiplexors 703 and 704 enables each input of arithmetic logic unit 705 to be capable of receiving:
i. the contents of any one of general registers R0 through R15; or
ii. the contents of the stack register N,
iii. a literal value that is given to it by instruction decoder 710, and
iv. the contents of top-of-stack register 702,
   which is a salient advantage of the illustrative embodiment over processor in the prior art. This is described below in detail and with respect to FIGS. 9, 10, and 11. It will be clear to those skilled in the art, after reading this disclosure, how to make and use register file 701.

Multiplexor 703 is a three-to-one multiplexor that selects one of:

i. a literal value that is given to it by instruction decoder 710,

ii. the contents of top-of-stack register 702, and

iii. the output of the first read port of register file 701

under the control of instruction decoder 710. It will be clear to those skilled in the art, after reading this disclosure, how to make and use multiplexor 703. Furthermore, it will be clear to those skilled in the art, after reading this disclosure, how to make and use alternative embodiments of the present invention in which multiplexor 703 has additional inputs to accommodate other inputs, such as, for example and without limitation, pipeline bypass paths and additional functional units.

Multiplexor 704 is a three-to-one multiplexor that selects one of:

i. a literal value that is given to it by instruction decoder 710,

ii. the contents of top-of-stack register 702, and

iii. the output of the second read port of register file 701

under the control of instruction decoder 710. It will be clear to those skilled in the art, after reading this disclosure, how to make and use multiplexor 704. Furthermore, it will be clear to those skilled in the art, after reading this disclosure, how to make and use alternative embodiments of the present invention in which multiplexor 704 has additional inputs to accommodate other inputs, such as, for example and without limitation, pipeline bypass paths and additional functional units.

Arithmetic logic unit 705 performs the logical and arithmetic operations on the operands that are presented to it by multiplexor 703 and 704. The output of arithmetic logic unit 705 can be written to main memory 711 and to multiplexor 706. It will be clear to those skilled in the art how to make and use arithmetic logic unit 705.

Multiplexor 706 is a two-to-one multiplexor that selects one of:

i. the output of arithmetic logic unit 705 (i.e., the resultant), and

ii. a value from memory

for delivery to

i. register file 701, and

ii. top-of-stack register 702

under the control of instruction decoder 710. This enables processor 700 to load either the output of arithmetic logic unit 705 or a value from memory into one or more registers in register file 701 and into top-of-stack register 702. It will be clear to those skilled in the art, after reading this disclosure, how to make and use multiplexor 706. Furthermore, it will be clear to those skilled in the art, after reading this disclosure, how to make and use alternative embodiments of the present invention in which multiplexor 706 has additional inputs to accommodate other inputs, such as, for example and without limitation, pipeline bypass paths and additional functional units.

FIG. 9 depicts the instruction format of 15 instructions in accordance with the illustrative embodiment, which has a programming model that comprises a stack, 16 general registers, and 16 32-bit general registers and a 32-bit main memory address space.

The family of control instructions—“CTRL”—are used to perform the various administrative and/or housekeeping functions on processor 700 that do not involve the arithmetic logic unit 705. This instruction group includes some housekeeping instructions and the NOP or “no operation” instruction.

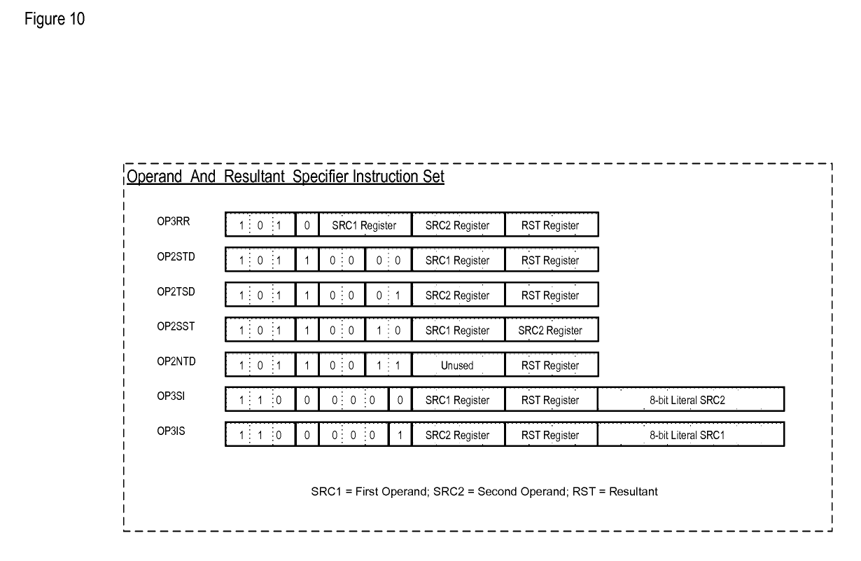

The family of arithmetic and logic instructions—“ALU”—are used to perform fundamental arithmetic and logical functions (e.g., such as addition, subtraction, multiplication, division, logical AND, logical OR, logical Exclusive-OR, etc.). Processor 700 functions, by default, as a zero-address machine, which means:
(1) there are no operand fields in an ALU instruction because processor 700 reads the operands from the stack unless the ALU instruction is preceded by an operand specifier, which specifies that either or both of the operands is to be read from a general register rather than the stack; and
(2) there is no resultant field in an ALU family because processor 700 stores the resultant onto the stack unless the ALU instruction is preceded by a resultant specifier, which specifies that the resultant is to be stored into a general register rather than the stack.
   The operand and resultant specifiers are described in detail below and with respect to FIG. 10. In the case of monadic functions, such as complement or sign-extend, there is only one operand.

The family of memory access instructions—MRD (memory read) and MWR (memory write), MRDX (memory read indexed) and MWRX (memory write indexed)—transfer values between memory and register file 701. The one-byte formats shown, with only four bits to specify the read or write function, are for use with addresses on operand stack 802 or in special-purpose address registers that are not shown in FIG. 7. It will be clear to those skilled in the art, after reading this specification, how to make and use alternative embodiments of the present invention in which one-byte formats are for use with a small set of dedicated, address registers.

The MRDX (memory read indexed) and MWRX (memory write indexed) instructions include fields to specify a base register (among general registers 1-7 only in accordance with the illustrative embodiment, so as to be unambiguous with the OP3SI and OP3IS instructions described in detail below and with respect to FIG. 10), a source or resultant register and a displacement value to be added to the value of the base register to calculate the address in data memory.

The PUSH instruction copies the value of the specified general register into top-of-stack register 702, while pushing the previous contents of top-of-stack register 702 down onto stack 802. It will be clear to those skilled in the art, after reading this disclosure, how to make and use alternative embodiments of the present invention in which the PUSH instruction is treated as an operand specifier rather than as an imperative instruction, as is discussed in detail below. The POP instruction moves the value in top-of-stack register 702 into the specified general register, and pops the next value on stack 802 into top-of-stack register 702. It will be clear to those skilled in the art, after reading this disclosure, how to make and use alternative embodiments of the present invention in which the POP instruction is treated as an operand specifier rather than as an imperative instruction, as is discussed in detail below.

The family of conditional-branch instructions—BCOND—are instructions that add their address offset to the program counter when and only when the element of processor internal state designated by the condition field is true. In most processors, one of the selectable conditions is “true” which yields an unconditional branch.

The LIT8 instruction performs the specified literal function, using the 8-bit literal value contained in the second byte of the instruction. Similarly, LIT16 performs the specified literal function, using the 16-bit literal value contained in the second and third bytes of the instruction. The literal function may pertain to treatment of the literal value (e.g., as signed or unsigned), or may pertain to disposition of this value (e.g., replace resultant, add to resultant, subtract from resultant, insert into high-order halfword of resultant, perform non-destructive compare with resultant value, etc.). It will be clear to those skilled in the art, after reading this disclosure, how to make and use alternative embodiments of the present invention in which the LIT8 and LIT16 are operand specifiers rather than imperative instructions, as is discussed in detail below.

The family of flow control instructions—JUMP and CALL—causes an unconditional change in program flow by modifying the program counter using the address offset contained in the instruction. The CALL instruction functions identically to the JUMP instruction, except that the CALL instruction causes the return address following the CALL instruction to be saved in an address stack (which is not depicted in the figures) or general register to permit the called procedure to return to the calling procedure.

The OTHER instruction is available for encoding additional instruction types and/or variants of existing instruction types as will be understood by one skilled in the art.

FIG. 10 depicts the instruction format of seven (7) Operand_And_Resultant Specifier Instructions in accordance with the illustrative embodiment. Each Operand_And_Resultant Specifier Instruction comprises:
i. a first operand specifier that overrides the default location for the first operand from the stack to a general register or a literal, or
ii. a second operand specifier that overrides the default location for the second operand from the stack to a general register or a literal, or
iii. a resultant specifier that overrides the default location for the resultant, or
iv. any combination of i, ii, and iii.
   Although the illustrative embodiment comprises seven (7) Operand_And_Resultant Specifier Instructions, it will be clear to those skilled in the art, after reading this disclosure, how to make and use alternative embodiments of the present invention that use any subset of the seven (7) Operand_And_Resultant Specifier Instructions. For example, it will be clear to those skilled in the art, after reading this disclosure, that the Operand_And_Resultant Specifier Instructions that are appropriate for a given processor are dictated primarily by the overall instruction set encoding architecture and the code generation technique(s) used by the primary language compiler(s) for that architecture.

In accordance with the illustrative embodiment, each Operand_And_Resultant Specifier Instructions is effective for only one subsequent ALU instruction. It will be clear to those skilled in the art, however, after reading this disclosure, how to make and use alternative embodiments of the present invention in which the effect of some or all operand specifiers persists for longer than one ALU instruction (e.g., until a “restore default operand locations” instruction is executed, etc.)

The OP3RR Operand_And_Resultant Specifier Instruction overrides the default locations in the stack with general register addresses for both operands (the first operand and the second operand) and the resultant. A OP3RR Operand_And_Resultant Specifier Instruction followed by an ALU instruction provides equivalent functionality to a three-address operation on a typical RISC processor in the prior art. One advantage of the illustrative embodiment is that the OP3RR Operand_And_Resultant Specifier Instruction is two bytes long and an ALU instruction is one byte long and so a three-address operation on this processor can be fully defined in 24 bits, which compares favorably with the 32 bits required to define a three-address instruction on most RISC processors in the prior art. Furthermore, for reasons explained in detail below, an Operand_And_Resultant Specifier Instruction and an ALU instruction pair can generally be executed in a single cycle and thereby achieve the same performance as the single, three-address RISC instruction in the prior art.

The OP2STD Operand_And_Resultant Specifier Instruction overrides the default locations of the first operand and the resultant with general register addresses, while reading the second operand from the stack. This facilitates using the stack to hold non-reused intermediate results during expression evaluation, while storing the values of frequently referenced variables and reused subexpressions in general registers.

The OP2TSD Operand_And_Resultant Specifier Instruction overrides the default locations of the second operand and the resultant with general register addresses, while reading the first operand from the stack. It will be clear to those skilled in the art, after reading this disclosure, how to make and use alternative embodiments of the present invention that do not include both the OP2STD Operand_And_Resultant Specifier Instruction and the OP2TSD Operand_And_Resultant Specifier Instruction, but it will be appreciated that embodiments of the present invention that do include both enables full flexibility for stack and general register operand locations for non-commutative ALU functions.

The OP2SST Operand_And_Resultant Specifier Instruction overrides the default locations of the first operand and the second operand with general register addresses, while storing the resultant onto the stack. This facilitates pushing onto the stack the intermediate result of an operation between two register values.

The OP2NTD Operand_And_Resultant Specifier Instruction overrides the default location of the resultant while obtaining both the first and second source operands from the stack. Because only one default location is overridden, one of the two register address fields in the OP2NTD instruction is unnecessary, and may be left unused, as illustrated in FIG. 10, or may be used to encode instruction functions other than operand and resultant location selection.

The OP3SI Operand_And_Resultant Specifier Instruction overrides the default locations for both operands and the resultant and provides a general register address for the first operand and the resultant, and provides an 8-bit literal value that is to be used as the second operand.

The OP3IS Operand_And_Resultant Specifier Instruction overrides the default locations for both operands and the resultant and provides a general register address for the first operand and the resultant, and provides an 8-bit literal value that is to be used as the first operand.

Although an Operand_And_Resultant Specifier Instruction and a ALU instruction are separate machine instructions, instruction decoder 710 in accordance with the illustrative embodiment is designed to recognize and execute such a pair in a single cycle. This is possible because the Operand_And_Resultant Specifier Instruction does not move any data, and, therefore, it is not necessary to have a superscalar data path to execute an operand specifier/ALU instruction pair in a single cycle.

It will be clear to those skilled in the art, after reading this disclosure, that an instruction that provides a single source operand from within the central data path (e.g., PUSH, LIT8, LIT16, etc.) can be implemented as an Operand_And_Resultant Specifier Instruction with the advantage of a savings in execution cycles, but at the cost of complexity in instruction decoder 710 and operand access logic.

It will be clear to those skilled in the art, after reading this disclosure, how to make and use alternative embodiments of the present invention in which instructions like PUSH, LIT8, and/or LIT16 (collectively known as single-operand specifiers) are decoded and processed as specifiers rather than as normal, imperative instructions. In these cases, the handling of default operands might be somewhat more complex. In addition to the direct replacement of default source operand locations with the alternative locations provided by the OP3xx and OP2xxx Operand_And_Resultant Specifier Instructions, the handling of single-operand specifiers requires some sequential modification of default source operand locations. In particular, the specification of a source register (with Push) or a source literal (with LIT8 or LIT16) needs to yield net results that are equivalent to the stack push that would have occurred if the single-operand specifier had been executed when decoded. Therefore, when a single-operand specifier is interpreted, the second operand location needs to be set to the specified general register or literal holding register, the first operand location needs to be changed to the original the second operand location (top-of-stack register 702 rather than stack register N), and the former value of stack register N needs to be “pushed” onto the stack in the register file. Because the value of stack register N is already within register file 701, this “push” can be recorded by housekeeping logic within instruction decoder 710, and no physical data movement is required.

This also explains why, after interpretation of an OP2TSD Operand_And_Resultant Specifier Instruction, that the first operand is defined above to be the “modified default” location top-of-stack register 702 rather than the normal default the first operand location stack register N. OP2TSD explicitly provides register locations for the second operand and resultant, while leaving the first operand to come from the stack. Because the logical top of stack is the second operand, overriding the second operand location is equivalent to pushing a value on the stack by executing a single-operand specifier. Therefore, at the time the following ALU operation is performed, the next-on-stack value is the initial value of top-of-stack register 702, with the initial value of stack register N being the third element on the stack.

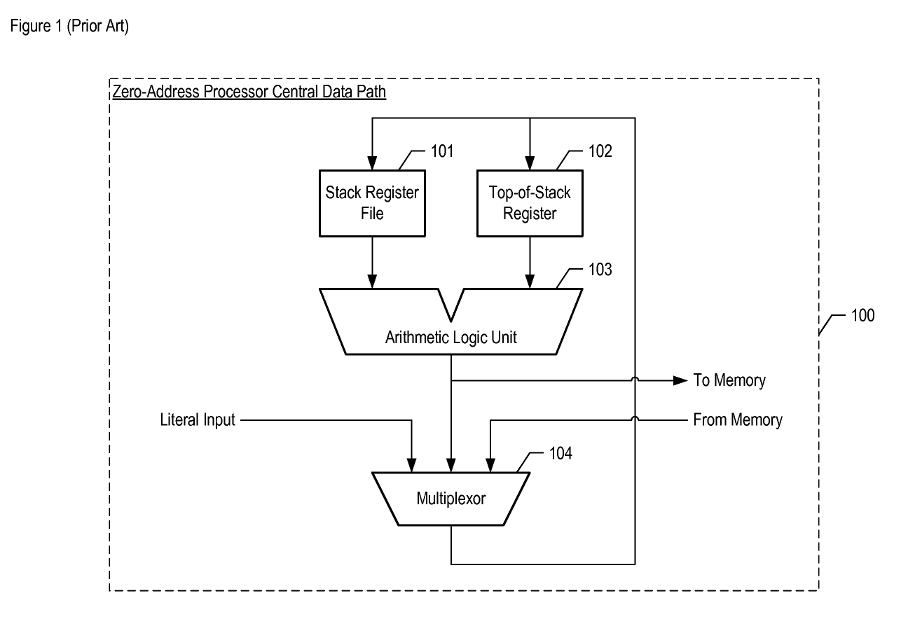

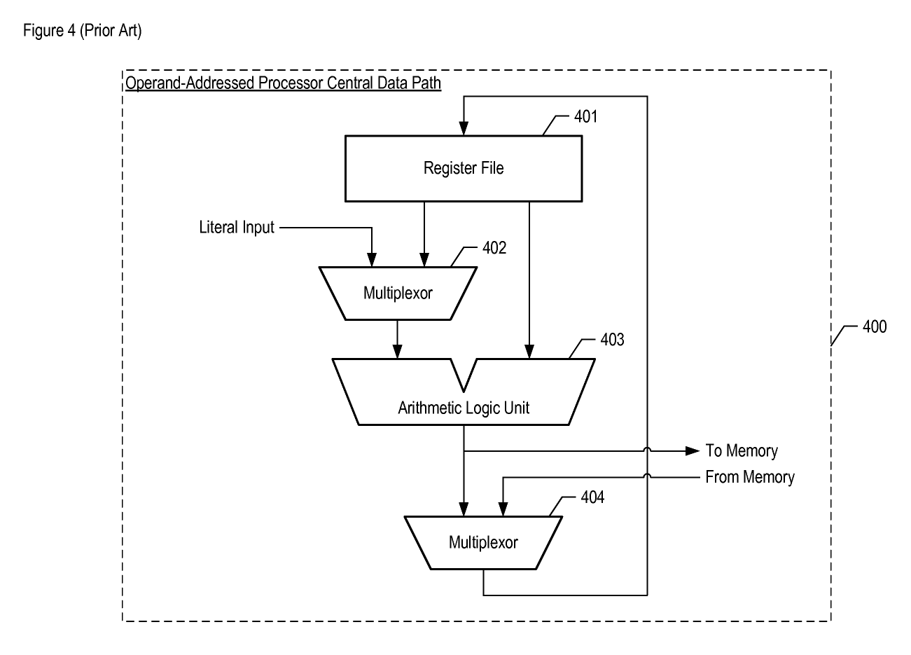

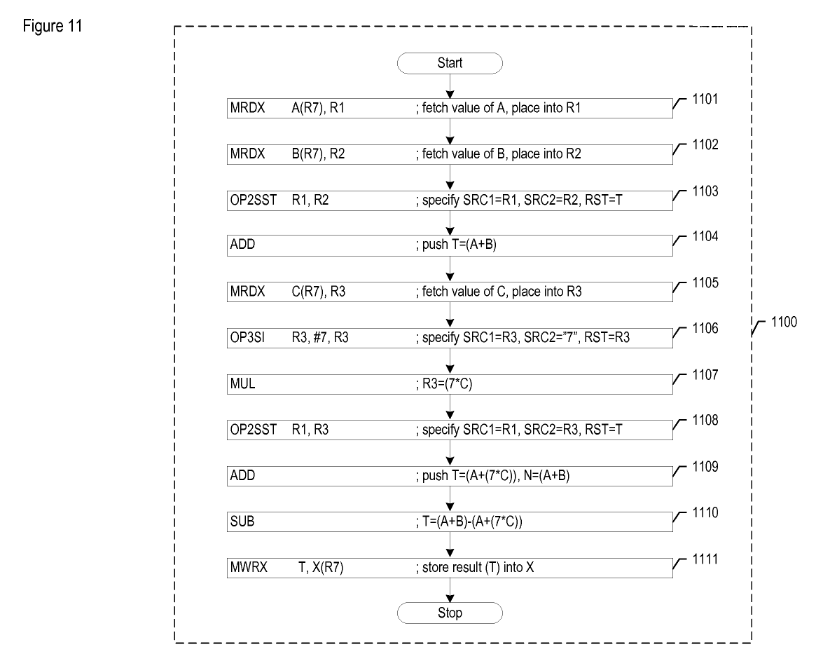

FIG. 11 depicts a program for evaluating Expression 1 in accordance with the illustrative embodiment. The program comprises 11 instructions, which occupy 22 bytes of code, and can execute in 8 cycles. This is a savings of 1 execution cycle and 14 bytes in comparison to the register-oriented processor in FIG. 4 and equal in size and able to execute in 2 fewer execution cycles in comparison to the stack-oriented machine in FIG. 1.

At task 1101, the MRDX A(R7), R1 instruction copies the value of A from memory into general register R1. The base address of the program's data area is being stored in general register R7.

At task 1102, the MRDX B(R7), R2 instruction copies the value of B from memory into general register R2.

At task 1103, the OP2SST R1, R2 Operand_And_Resultant Specifier Instruction specifies the first operand and the second operands for the next ALU operation are in general registers rather than on the stack, but the resultant of the resultant remains the stack. In particular, the instruction specifies that the first operand is in general register R1 and that the second operand is in general register R2.

At task 1104, the ADD instruction adds the values in general registers R1 and R2 and store the result into top-of-stack register 702. In accordance with the illustrative embodiment, the ADD instruction is executed in parallel with the operand specifier instruction in task 1103, but it will be clear to those skilled in the art, after reading this disclosure, how to make and use alternative embodiments of the present invention in which the ADD instruction is executed separately from the operand specifier instruction.

At task 1105, the MRDX C(R7), R3 instruction executes, which copies the value of C from memory into general register R3.

At task 1106, the OP3SI Operand_And_Resultant Specifier Instruction specifies that the first operand for the next ALU operation is in a general register, that the second operand is a literal, and that the result is to be stored in a general register rather than pushed onto the stack. In particular, the instruction specifies that the first operand is in general register R3, the second operand is the literal “7,” and the result is to be stored in general register R3.

At task 1107, the MUL ALU instruction multiplies the value in general register R3 by the literal “7” and stores the result in general register R3. In accordance with the illustrative embodiment, the MUL instruction is executed in parallel with the operand specifier instruction in task 1106, but it will be clear to those skilled in the art, after reading this disclosure, how to make and use alternative embodiments of the present invention in which the MUL instruction is executed separately from the operand specifier instruction.

At task 1108, the OP2SST Operand_And_Resultant Specifier Instruction specifies the first operand and the second operands for the next ALU operation are in general registers, but the resultant of the resultant remains the stack. In particular, the instruction specifies that the first operand is in general register R1 and that the second operand is in general register R3.

At task 1109, the ADD ALU instruction adds the values in general register R1 and R3, and pushes the result into top-of-stack register 702. In accordance with the illustrative embodiment, the ADD instruction is executed in parallel with the operand specifier instruction in task 1108, but it will be clear to those skilled in the art, after reading this disclosure, how to make and use alternative embodiments of the present invention in which the ADD instruction is executed separately from the operand specifier instruction.

At task 1110, the SUB ALU instruction subtracts the top two values on the stack and pushes the difference into top-of-stack register 702.

At task 1111, the MWRX instruction pops the value off of the stack and stores it into memory at the address whose base value is stored in general register R7 and whose offset is in the instruction.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

The following claims are presented for examination:

1. A processor comprising:
(a) a stack comprising a plurality of stack registers;
(b) a first general register;
(c) a second general register;
(d) a third general register;
(e) an instruction decoder for capable of decoding and orchestrating the performance of:
(i) a first instance of a zero-address dyadic instruction in which the first operand is read from said first general register, the second operand is read from said second general register, and the resultant is stored into said third general register; and
(ii) a second instance of said zero-address dyadic instruction in which the first operand is popped off of said stack, said second operand is popped off of said stack, and the resultant is pushed onto said stack.

2. The processor of claim 1 wherein said instruction decoder is also capable of decoding and orchestrating the performance of (iii) a third instance of said zero-address dyadic instruction in which the first operand is read from said first general register, the second operand is popped off of said stack, and the resultant is stored into said third general register.

3. The processor of claim 1 wherein said instruction decoder is also capable of decoding and orchestrating the performance of (iii) a third instance of said zero-address dyadic instruction in which the first operand is read from said first general register, the second operand is popped off of said stack, and the resultant is pushed onto said stack.

4. The processor of claim 1 wherein said instruction decoder is also capable of decoding and orchestrating the performance of (iii) a third instance of said zero-address dyadic instruction in which the first operand is read from said first general register, the second operand is read from said second general register, and the resultant is pushed onto said stack.

5. The processor of claim 1 wherein said instruction decoder is also capable of decoding and orchestrating the performance of (iii) a third instance of said zero-address dyadic instruction in which the first operand is popped off of said stack, said second operand is popped off of said stack, and the resultant is stored into said first general register.

6. A processor comprising:
(a) a stack comprising a plurality of stack registers;
(b) a first general register;
(c) a second general register; and
(d) an instruction decoder capable of decoding and orchestrating the performance of (i) a first instance of a zero-address dyadic instruction in which the first operand is read from said first general register, the second operand is popped off of said stack, and the resultant is stored into said second general register.

7. The processor of claim 6 wherein said instruction decoder is also capable of decoding and orchestrating the performance of (ii) a second instance of said dyadic instruction in which the first operand is read from said first general register, the second operand is popped off of said stack, and the resultant is pushed onto said stack.

8. The processor of claim 6 wherein said instruction decoder is also capable of decoding and orchestrating the performance of (ii) a second instance of said dyadic instruction in which the first operand is popped off of said stack, said second operand is popped off of said stack, and the resultant is pushed onto said stack.

9. The processor of claim 6 further comprising (e) a third general register; and
wherein said instruction decoder is also capable of decoding and orchestrating the performance of (ii) a second instance of said dyadic instruction in which the first operand is read from said first general register, the second operand is read from said second general register, and the resultant is stored into said third general register.

10. The processor of claim 6 wherein said instruction decoder is also capable of decoding and orchestrating the performance of (iii) a second instance of said zero-address dyadic instruction in which the first operand is read from said first general register, the second operand is read from said second general register, and the resultant is pushed onto said stack.

11. The processor of claim 6 wherein said instruction decoder is also capable of decoding and orchestrating the performance of (iii) a second instance of said zero-address dyadic instruction in which the first operand is popped off of said stack, said second operand is popped off of said stack, and the resultant is stored into said first general register.

12. A processor comprising:
(a) a stack comprising a plurality of stack registers;
(b) a first general register; and
(c) an instruction decoder capable of decoding and orchestrating the performance of (i) a first instance of a zero-address dyadic instruction in which the first operand is read from said first general register, the second operand is popped off of said stack, and the resultant is pushed onto said stack.

13. The processor of claim 12 further comprising (d) a second general register; and
wherein said instruction decoder is also capable of decoding and orchestrating the performance of (ii) a second instance of said dyadic instruction in which the first operand is read from said first general register, the second operand is popped off of said stack, and the resultant is stored into said second general register.

14. The processor of claim 12 wherein said instruction decoder is also capable of decoding and orchestrating the performance of (ii) a second instance of said dyadic instruction in which the first operand is popped off of said stack, said second operand is popped off of said stack, and the resultant is pushed onto said stack.

15. The processor of claim 12 further comprising:
(d) a second general register; and
(e) a third general register;
wherein said instruction decoder is also capable of decoding and orchestrating the performance of (ii) a second instance of said dyadic instruction in which the first operand is read from said first general register, the second operand is read from said second general register, and the resultant is stored into said third general register.

16. The processor of claim 12 further comprising (d) a second general register; and
wherein said instruction decoder is also capable of decoding and orchestrating the performance of (iii) a second instance of said zero-address dyadic instruction in which the first operand is read from said first general register, the second operand is read from said second general register, and the resultant is pushed onto said stack.

17. The processor of claim 12 further comprising (d) a second general register; and
wherein said instruction decoder is also capable of decoding and orchestrating the performance of (iii) a second instance of said zero-address dyadic instruction in which the first operand is popped off of said stack, said second operand is popped off of said stack, and the resultant is stored into said first general register.

18. A processor comprising:
(a) a stack comprising a plurality of stack registers;
(b) a first general register; and
(c) an instruction decoder capable of decoding and orchestrating the performance of (i) a first instance of a zero-address dyadic instruction in which the resultant of said first instance of a zero-address dyadic instruction is, by default, pushed onto said stack unless a resultant specifier indicates that said resultant is to be stored into said first general register.

19. The processor of claim 18 further comprising (d) a second general register; and
wherein the first operand of said first instance of a zero-address dyadic instruction is, by default, popped off of said stack unless a first operand specifier indicates that said second operand is read from said second general register.

20. The processor of claim 19 further comprising (e) a third general register; and
wherein the second operand of said first instance of a zero-address dyadic instruction is, by default, also popped off of said stack unless a second operand specifier indicates that said second operand is read from said third general register.
